(19) United States
(12) Patent Application Publication
(10) Pub. No.: US 2007/0092363 A1
(43) Pub. Date: Apr. 26, 2007

(54) Rolling tilt deck for a truck bed

(76) Inventor: Mark Morfitt, Post Falls, ID (US)

Correspondence Address: PATENT LAW & VENTURE GROUP, 2424 S.E. BRISTOL, SUITE 300, NEWPORT BEACH, CA, 92660, US

(21) Appl. No.: 11/245,741

(22) Filed: Oct. 7, 2005

(51) Int. Cl. B60P 1/04

(52) U.S. Cl. 414/467

(57) ABSTRACT

A tilting ramp apparatus is placed within a truck bed for loading, unloading and transporting a personal recreational vehicle. The apparatus comprises a rigid ramp having a surface plate mounted on a pair of spaced apart, downwardly facing C-channels, and a first pair of wheels engaged with and depending downwardly from the C-channels for rolling on the truck bed. An engagement bar is removably engaged with a tow bar receiver of the truck. A wheel support bar integral with and extending upwardly from the engagement bar is oriented in orthogonal juxtaposition thereto. The wheel support bar provides a second pair of wheels extending upwardly and spaced apart so as to engage the C-channels.

### BACKGROUND

1. Field of the Present Disclosure

This disclosure relates generally to loading devices for trucks and more particularly to a rolling and tilting loading ramp operating within a truck bed.

2. Description of Related Art

Scherle, U.S. 2004/0008055, discloses a tilting ramp for mounting to a truck, and once so mounted can be used for loading, unloading and transport a personal recreational vehicle. The ramp is slidable over a bed of the truck. A pivot member is mounted into a receiver tube mounted to the truck. The pivot member extends upwardly into translational engagement with the ramp. The ramp may be translated over both the bed and the pivot member between a transport position forward on the bed and a pivoting position pivotal about the pivot member. In the pivoting position the ramp is pivotal between the horizontal and an inclined position in engagement with the ground surface. Panciocco, U.S. Pat. No. 3,471,045, discloses a device for the bed of a pickup truck that includes a U-shaped channel secured to the inner surface of each side wall of the bed of the pickup truck that is parallel to and at a first predetermined height above the floor, with the opening of the channel facing inwardly. A first auxiliary box including a floor, a front wall and parallel side walls having rollers secured to the exterior surfaces thereof disposed for rolling relationship with the channels. A second U-shaped channel secured to the inner surface of each side wall, parallel to and at a second predetermined height above the floor with the opening of the second channel facing inwardly. A carriage comprising side beams, front and rear beams, the beams being secured at the corners to form a rectangular unitary structure. A first hinge section is welded to the rear beam, a threaded member secured at the center of and extending below the front beam, roller axles secured to the front and rear beams and extending perpendicularly beyond the side beams at each corner. Additional roller affixed to the roller axles, the carriage being arranged for rolling relationship between the additional rollers and the second channels, the second predetermined distance being greater than the first predetermined distance by an amount sufficient to permit the carriage to clear the first auxiliary box. A second auxiliary box including a floor, a front wall, parallel side walls and a tailgate with a second hinge section secured to the floor thereof adapted to form a butt hinge with the first hinge section to permit rotation of the second auxiliary box with respect to the carriage. An electric winch motor mounted on the front wall of the open bed connected through a reversing switch to the truck's electric power system and a threaded drive rod secured to the winch motor dive shaft and threadably engaged with said thread member, the drive rod being of such length that when driven by the winch motor, the carriage may be moved to the rear of the truck. Nydam et al., U.S. Pat. No. 3,768,673, discloses a load-carrying platform that is roller-mounted on rails normally secured to the floor of a truck, and is arranged to move from a forward position over the floor of the truck to a rearwardly-extended position overhanging the rear end of the truck. At the rearward extreme of this movement, the rails release the platform for tilting on the truck to form an inclined loading ramp. Mabry, Jr., U.S. Pat. No. 3,915,496, discloses a dumping vehicle that consists of a unit that is adapted to be placed in a pickup truck whereby loads or cargo can be conveniently dumped from the vehicle. The dumping vehicle includes a moveable body as well as a suitable jack mechanism for selectively tilting the body, and wherein there is also provided a latching or locking means for the unit. Goser et al., U.S. Pat. No. 4,685,857, discloses an adjustable load-carrying apparatus that is designed for mounting on the load-carrying bed of a vehicle. It includes a base frame assembly which is fixed rigidly to the vehicle bed and has laterally spaced inwardly facing rollers in longitudinal alignment along each side edge thereof plus an inward lock guide rail. A slidable platform frame assembly has lateral trackways slidably mated with the rollers of the base frame. The platform frame assembly includes a lock guide structure on its underside in cooperative relationship with a lock guide rail of the base frame assembly. Additionally, the platform assembly includes on its underside laterally spaced ramp slideways. A ramp assembly is carried for sliding movement in the ramp slideways. It includes a ramp deck as well as a forward guide section and a hinge connection between the deck and the forward guide section whereby the ramp deck may be lowered for ramp use while a foundation portion of the forward guide section remains in the ramp slideways of the slidable frame assembly. Sloan, U.S. Pat. No. 4,741,575, discloses a pneumatically actuated dumping bin for a cargo bed of a vehicle that includes a floor, a left side wall, a right side wall and a rear wall. The pneumatic piston and cylinder is pivotally connected only to the bin at the rear wall portion with the cylinder being substantially vertical when the bin is horizontal. Compressed air selectively actuates the piston and cylinder to raise the bin at the rear wall portion when the bin substantially overhangs a rear end of the vehicle. Dinverno, U.S. Pat. No. 5,183,372, discloses service cart transportable in a van or truck that is comprised of a vertically oriented pyramid-shaped profile. The pyramid shape offers a high degree of stability, making it virtually impossible to tip over during normal operating conditions, especially during transport. The cart has a four wheel base. One set of wheels is preferably swivel casters for turning sharp corners. A second set of wheels is larger and located externally of the cart. These wheels increase the base of the pyramid profile and add to the cart's stability. The service cart may be transported to and from a job site. The cart fits into a van or truck bed. To remove the cart from the vehicle, a ramp system is provided. A mechanical or electrical winch may be used to transport the cart into or out of the vehicle. Flowers, U.S. Pat. No. 5,380,141, discloses an invention that provides a system and a method for lifting and transporting vehicles, such as a snowmobile or other recreational vehicle. The system includes a frame member having a first rail member and attached to a vehicle, a second rail member moveable along the first rail member into a deployment position wherein it extends rearwardly of the frame, a moveable support member which can extend supportively between the second rail member and the ground, and a platform member slidable along the first and second rail members. The method of the invention may employ a system of the invention and involves moving a second rail member into a deployment position extending rearwardly of a frame, moving a support member into position to support the second rail member, sliding a platform rearwardly along first and second rail members to position the platform generally rearwardly of the transport vehicle, and lowering the rearward end of the second rail member to position its rearward end adjacent the ground for loading the vehicle onto the platform. Hall, et al., U.S. Pat. No. 5,393,192, discloses a tray that is mountable under the floor of a vehicle, which tray contains an extendible ramp mechanism. This mechanism comprises a ramp and a driving panel for the ramp. The ramp is fulcrummed intermediate its ends on the outer ends of parallel arms extending from the driving panel. Also in the tray, as part of the driving mechanism, are a pair of parallel toothed belts driven by a reversible rotating motor, which belts are attached to the driving panel for extending and retracting the ramp from the tray. Mounted under the driving panel is a reciprocating motor connected by a crank arm to a shaft having additional crank arms pivotally connected to the underside of the ramp adjacent the driving panel. When the ramp is fully extended, the reciprocating motor tilts the ramp so that its inner end is moved upwardly to be flush with the floor of the vehicle. Simultaneously, the outer end of the ramp contacts the ground. The ramp has parallel side barriers which spring into position when the ramp is fully extended. These barriers are automatically folded against the top surface of the ramp by an angularly-mounted roller which contacts a cammed surface at the inner ends of each barrier as the ramp is retracted into the tray. Berens, U.S. Pat. No. 5,454,684, discloses an auxiliary mechanism for use with a utility vehicle. The auxiliary mechanism is adapted to be removably installed within the storage area of the utility vehicle and to be movable into and out of the rear or side of the vehicle to a loading and dumping position. Movement of the auxiliary mechanism is under control of a closed loop cable system and dumping is accomplished under control by a screw jack. Stops register the movable portions of the mechanism for stowed, loading, predumping and dumping positions. Olaussen et al., U.S. Pat. No. 5,794,291, discloses a ramp for loading and unloading snowmobiles and other vehicles from a load bed such as a trailer or transport vehicle. The ramp comprises a pair of longitudinal tracks joined by a plurality of transverse members. Such transverse members are adapted to receive the wheels of the objects being transported or, in the case of snowmobiles, the belt grip thereof. In the case of snowmobiles, the skis of such vehicle are received on the longitudinal tracks. The ramp includes a pair of wheels for use in moving the ramp across the load bed. The wheels are positioned at a location on the ramp corresponding to the center of mass of such ramp when supporting the snowmobile or other such vehicle. The tracks of the ramp are preferably angled upwards to avoid contact with the load bed when being moved across same. The spacing of such tracks is adjustable so as to permit transport of the vehicles having a variety of widths. Stanley, U.S. Pat. No. 5,829,945, discloses a roll-out deck apparatus that is fitted to a pick-up truck, for loading/unloading a snowmobile etc. The deck may be tilted about a hinge pivot at the rear edge of the truck, whereby the deck forms a ramp, up and down which the snowmobile may be manipulated. The apparatus includes an electric winch, located at the front end of the deck, for raising and lowering the deck, about the hinge pivot. A sub-frame of the apparatus is directly hinged to the rear edge of the truck bed; the sub-frame can undergo pivoting or tilting movement about the hinge pivot. A deck-frame has a telescoping relationship with respect to the sub-frame, but is otherwise locked to the sub-frame, whereby when the sub-frame tilts the deck-frame tilts in unison.

Our prior art search with abstracts described above teaches a truck bed ramp system with rolling contact on the truck bed and an element about which the ramp may tilt between horizontal and tilted positions. The Scherle reference U.S. 2004/0009055 teaches a tilt out ramp similar to the present invention but fails to teach inverted channel construction on the ramp where the channels engage and roll on rearwardly mounted wheels. The present disclosure distinguishes over the prior art providing heretofore unknown advantages as described in the following summary.

### SUMMARY

This disclosure teaches certain benefits in construction and use which give rise to the objectives described below.

A tilting ramp apparatus is placed within a truck bed for loading, unloading and transporting a personal recreational vehicle. The apparatus comprises a rigid ramp having a surface plate mounted on a pair of spaced apart, downwardly facing C-channels, and a first pair of wheels engaged with and depending downwardly from the C-channels for rolling on the truck bed. An engagement bar is removably engaged with a tow bar receiver of the truck. A wheel support bar integral with and extending upwardly from the engagement bar is oriented in orthogonal juxtaposition thereto. The wheel support bar provides a second pair of wheels extending upwardly and spaced apart so as to engage the C-channels.

A primary objective inherent in the above described apparatus and method of use is to provide advantages not taught by the prior art.

Another objective is to provide a simplified way of loading and unloading cargo into a truck bed.

A further objective is to provide an apparatus that is easily moved between a horizontal position within a truck bed and a tilted position at the loading end of the truck bed.

A still further objective is to provide a ramp of such an apparatus that is able to track on wheels set at the loading end of the truck for motion guiding of ramp movement.

Other features and advantages of the described apparatus and method of use will become apparent from the following more detailed description, taken in conjunction with the accompanying drawings, which illustrate, by way of example, the principles of the presently described apparatus and method of its use.

### BRIEF DESCRIPTION OF THE DRAWINGS

The accompanying drawings illustrate at least one of the best mode embodiments of the present apparatus and method of it use. In such drawings:

FIG. 1 is a perspective view of the presently described apparatus showing a ramp thereof in a horizontal attitude and a wheel support bar thereof;

FIG. 2 is a further perspective view of the ramp and support bar thereof shown with the ramp fully engaged within a bed of a truck in which it is mounted;

FIGS. 3 is a side elevational views thereof showing the ramp in a tilted position with a recreational vehicle entering the ramp;

FIG. 4 is similar to FIG. 3 with the vehicle fully engaged with the ramp;

FIGS. 5-7 are similar to FIGS. 3 and 4 showing the method of use of the apparatus; in FIG. 5, starting to lift the ramp; in FIG. 6, positioning the ramp into a horizontal attitude; and in FIG. 7, rolling the ramp into the bed of the truck.

### DETAILED DESCRIPTION

The above described drawing figures illustrate the described apparatus and its method of use in at least one of its preferred, best mode embodiment, which is further defined in detail in the following description. Those having ordinary skill in the art may be able to make alterations and modifications what is described herein without departing from its spirit and scope. Therefore, it must be understood that what is illustrated is set forth only for the purposes of example and that it should not be taken as a limitation in the scope of the present apparatus and method of use.

The apparatus, in a first embodiment herein described and illustrated, is a combination, including a truck 10, a ramp 30 and a support bar 42. The truck provides a tow bar receiver 12 and a truck bed 14, the latter sized for loading, unloading and transporting a personal recreational vehicle 20 which is shown in FIGS. 4-7. The ramp 30 is of rigid construction, preferably made of steel and may have plastic sheets set onto the steel for a vehicle to ride on. It provides a surface plate 32 mounted on a pair of spaced apart, downwardly facing C-channels 34. The surface plate 32 may be a single plate covering the entire upwardly facing surface of the ramp 30, or, as shown in FIG. 2, it may comprise a pair of spaced apart surfaces 32. Preferably, cross bars 35 join the C-channels 34 and are preferably joined thereto by welding. The cross bars 35 are preferably hollow tubes for providing strength with light weight. A first pair of wheels 36 are engaged with and depending downwardly from the C-channels 34 near one end 38 of the ramp 30, the one end 38 being the end of the ramp 30 that is furthest from the loading end of the truck bed 14, i.e., forward in the vehicle when the ramp 30 is fully engaged within the truck bed 14.

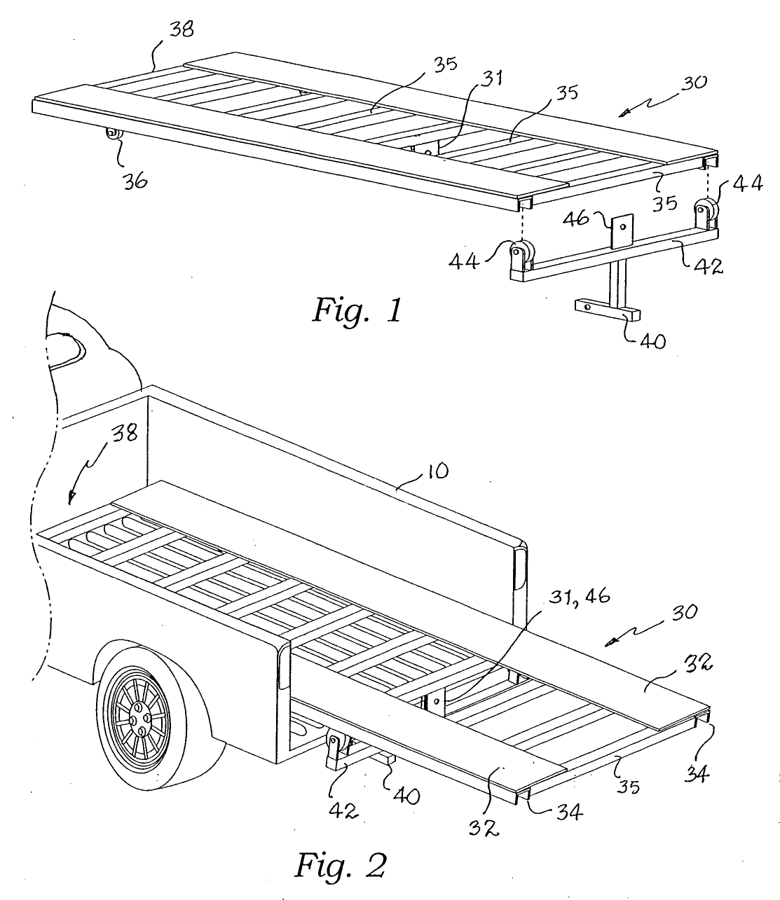

A tow bar 40, as best seen in FIG. 1, is removably engaged with the tow bar receiver 12 of the truck 10 and the relationship between a tow bar receiver 12 and a tow bar 40 is very well known in the art. In this case, the tow bar 40 is not used for towing a trailer or such, but rather its function is to support the ramp 30 as will be described and as shown in the attached figures. To accomplish this, a wheel support bar 42 is made integral with and upwardly extending from the tow bar 40 and this support bar 42 is oriented in orthogonal juxtaposition with respect to the tow bar 40. To make this well understood, the tow bar 40, when engaged with the tow bar receiver 12 is aligned with the longitudinal axis of the truck 10, while the support bar 42 is oriented laterally with respect to the truck 10. This relationship is clearly shown in FIG. 1. The wheel support bar 42 provides a second pair of wheels 44 extending upwardly therefrom, these wheels being fixedly secured to the bar 42 and able to freely rotate. This second pair of wheels 44 is spaced apart so as to engage the C-channels 34, so that the ramp 30 is able to move longitudinally into and out of the truck bed 14 while being supported by wheels 36.

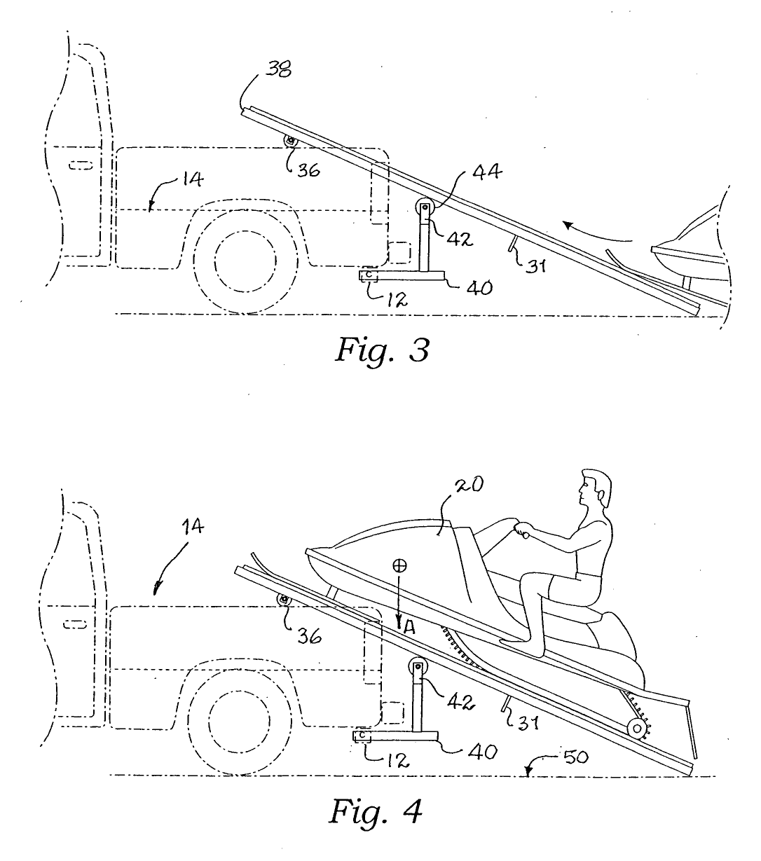

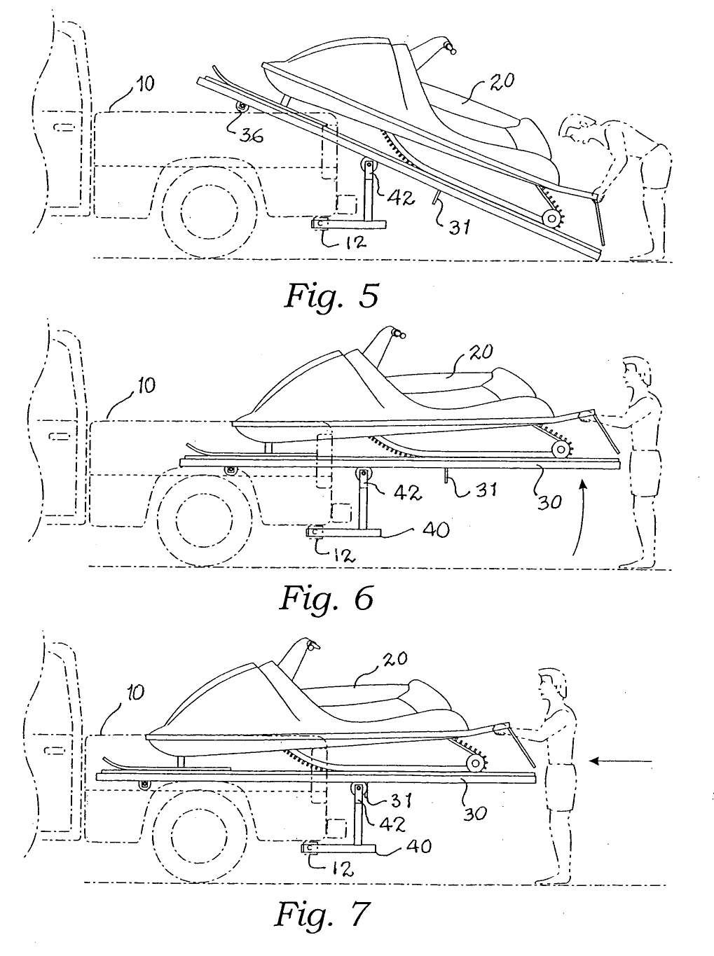

Ramp 30 is able to roll into the truck bed 14 on the first pair of wheels 36 which contact on the truck bed 14; the ramp 30 being further supported on the second pair of wheels 44 at the rear of the truck bed 14. The ramp 30 is able to freely tilt about the second pair of wheels 44 so as to move between the horizontal attitude, shown in FIG. 2, when rolling into or out of the truck bed 14, and the tilted attitude, shown in FIGS. 3-5, where a second end 39 of the ramp 30 contacts the road surface 50. With the ramp 30 in position as shown in FIGS. 3-5, clearly the center of weight of the ramp 30 is over the road surface 50 and the ramp 30 is in stable equilibrium in that position and attitude. However, when a recreational vehicle 20 is driven up onto the ramp 30 so that the vehicle's center of weight, shown by the weight vector “A” in FIG. 4, is forward of the second pair of wheels 44, the ramp and vehicle together have a center of weight that is approximately over the second pair of wheels 44 making it very easy to manually lift the ramp 30 and upon doing so, as the ramp is lifted (FIGS. 5 and 6), the joint center of weight moves forward into the truck bed 14 so that when the ramp 30 is in the horizontal position with the recreational vehicle 20 on top of it, the ramp 30 and vehicle 20 are again in a position of stable equilibrium and ready for transport.

A first lock tab 46 extends upwardly from the wheel support bar 42, and a second lock tab 31 extends downwardly from the ramp 30, the first and second tabs 46, 31 are in contact when the ramp 30 is fully engaged or inserted into the truck bed 14, as shown in FIG. 2. Each of the tabs 31 and 46 provide a means for mutual engagement such as the holes shown where a pad lock may be inserted into the holes so that ramp 30 cannot move within the truck bed 14 when operating the truck 10.

The enablements described in detail above are considered novel over the prior art of record and are considered critical to the operation of at least one aspect of the apparatus and its method of use and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that each named inventor believes that the claimed subject matter is what is intended to be patented.

What is claimed is:

1. A tilting ramp apparatus mountable within a truck bed of a truck for loading, unloading and transporting a personal recreational vehicle, the apparatus comprising: a rigid ramp having a surface plate mounted on a pair of spaced apart, downwardly facing C-channels, and a first pair of wheels engaged with and depending downwardly from the C-channels near one end thereof; a tow bar having a means for removable engagement with a tow bar receiver of the truck; a wheel support bar integral with and extending upwardly from the tow bar and oriented in orthogonal juxtaposition thereto, the wheel support bar providing a second pair of wheels extending upwardly therefrom, the second pair of wheels spaced apart so as to engage the C-channels.

2. The apparatus of claim 1 further comprising a first lock tab extending upwardly from the wheel support bar, and a second lock tab extending downwardly from the ramp, the first and second tabs in contact and providing a means for mutual engagement for locking the ramp into the truck bed.

3. A combination apparatus comprising: a truck providing a tow bar receiver and a truck bed sized for loading, unloading and transporting a personal recreational vehicle; a rigid ramp having a surface plate mounted on a pair of spaced apart, downwardly facing C-channels, and a first pair of wheels engaged with and depending downwardly from the C-channels near one end thereof; a tow bar removably engaging the tow bar receiver of the truck; a wheel support bar integral with and extending upwardly from the tow bar and oriented in orthogonal juxtaposition thereto, the wheel support bar providing a second pair of wheels extending upwardly therefrom, the second pair of wheels spaced apart to engage the C-channels, wherein the ramp rolls in the truck bed on the first pair of wheels while being supported on the second pair of wheels; the ramp tilting about the second pair of wheels for moving from a horizontal attitude when rolling in the truck bed to a tilted attitude for contact with a road surface.

4. The apparatus of claim 3 further comprising a first lock tab extending upwardly from the wheel support bar, and a second lock tab extending downwardly from the ramp, the first and second tabs in contact and providing a means for mutual engagement for locking the ramp into the truck bed.

5. A tilting ramp apparatus mountable within a truck bed of a truck for loading, unloading and transporting a personal recreational vehicle, the apparatus comprising: a rigid ramp mounted on at least one downwardly facing C-channel; at least one wheel positioned within the at least one C-channel at a positioned enabling the ramp to pivot thereon.
